(19) United States
(12) Patent Application Publication
(10) Pub. No.: US 2003/0094479 A1
(43) Pub. Date: May 22, 2003

(54) Pad material retention apparatus and method for backing plates

(76) Inventors: Fred J. Callahan, Salisbury, MD (US); Ashley Page, Huntersville, NC (US)

Correspondence Address: Robert P. Simpson, Esq., Simpson, Simpson & Snyder, PLLC, 5555 Main Street, Williamsville, NY, 14221-5406, US

(21) Appl. No.: 09/992,978

(22) Filed: Nov. 16, 2001

(51) Int. Cl. B23K 20/14; B23K 31/02

(52) U.S. Cl. 228/41; 228/178

(57) ABSTRACT

An apparatus including a backing plate and at least one “U” shaped structure emanating from and secured to the backing plate to form a closed loop, and a method for attaching a pad of friction material to a backing plate are disclosed. The apparatus comprises at least one rigid structure attached to the backing plate in at least two places. These structures form at least one closed loop with the backing plate. The pad is formed around the structures, completely surrounding the structures. In the preferred embodiment, the structures are two “U” shaped loops made of friction material, so that the pad can continue to be used when the pad wears down to the level of the loops.

### FIELD OF THE INVENTION

This invention relates to the attachment of a pad of friction material to a backing plate. More specifically it relates to mechanically attaching a pad of friction material to a backing plate. Even more particularly, it relates to an apparatus and method for brake and clutch pad material attachment to a backing plate.

### BACKGROUND OF THE INVENTION

A disc brake system requires a brake pad to be attached to a backing plate. The backing plate is connected to the brake calipers. The brake calipers move the backing plate towards the brake rotor during braking, causing the pad to contact the rotor. Thus, the backing plate must be rigid to force the brake pad against the rotor. The pad is made of a friction material formulated to dissipate the kinetic energy of the vehicle as it contacts the rotor. The friction material is often a brittle substance that cannot be connected directly to the caliper. The problem is that the backing plate, often steel, must be somehow bonded to the very different friction material in a manner that can withstand the extreme temperatures and forces of braking

A drum brake pad also must be fixed to a backing plate. When the brakes are applied, the backing plate forces the friction material of the drum brake pad against the drum. Similar materials are used for backing plates and brake pads for both drum and disc brakes, leading to the same attachment problem.

Similarly, clutching systems require a clutch pad of friction material to be fixed to a backing plate. The frictional material of the clutch allows the clutch plate to lock up to the engine flywheel and transfer the torque from the engine to the transmission and on to the wheels of the vehicle.

Numerous attempts have been made to attach friction material to a backing plate. An early brake shoe, disclosed in U.S. Pat. No. 1,772,639 (Slade), fixes the friction material to the backing plate using stitches. Later, rivets were developed as shown in U.S. Pat. No. 2,239,574 (Schell). There can be several problems with rivets. One is that the pad can only be used until the friction material is worn to the level of the rivets. At that point, the rivets dig into the rotor, drum, or clutch. Also, the rivets are located in holes cut through the backing plate and pad, weakening both structures. The heavier the loads, the more rivets are needed to attach the pad to the plate, which increases the cost of manufacturing the pad.

The U.S. Pat. No. 4,991,697 (Hummel et al.) discloses a device to attach a brake pad to a backing plate. A metal mesh is welded in many places to a backing plate with a plurality of holes in it. Rods are inserted through the holes in the backing plate to bend the mesh away from the plate. The brake pad is then formed around the mesh. This device would likely be inefficient to produce. The plurality of holes in the backing plate and the plurality of welds would likely be cost intensive to make. The process of bending the mesh would likely increase the cost as well. In addition, the pad can only be used until the material wears down to the metal mesh.

A simpler brake pad retention apparatus is disclosed in U.S. Pat. No. 5,732,800 (Spigener). Metal clips are welded to the backing plate with the legs pointed away from the plate. The brake pad is formed over the clips. This may be easier to manufacture than the device disclosed by Hummel, however, it can also only be used until the pad wears down to the metal clips. Although the legs of the clips may be bent towards each other, the clips do not form a closed loop with the plate. Thus, although they may provide some support against forces normal to the plate, a chemical bond would likely be needed to insure that the pad stays on the plate. This chemical bond would likely increase the cost of manufacturing the apparatus.

Japanese Patent Nos. JP356031535A (Kawamoto et al.) and JP356080534A (Nakagawa et al.) disclose similar devices to that disclosed by Spigener. These devices have structures extending from the plate that may provide shear support to the brake pad, but cannot provide a retention force normal to the plate without chemical adhesives.

Chemical adhesives very likely increase the cost of manufacturing the brake pad, as well as the time it takes to produce it. Also, chemical adhesives may melt, bum, gas off, or liquefy at the high temperatures of extreme braking conditions.

Clearly, then, there is a longfelt need for a brake or clutch pad retention apparatus that is easily manufactured, reduces or eliminates the need for chemical adhesives, and can increase the depth of the pad available for use.

### SUMMARY OF THE INVENTION

The present invention broadly comprises an apparatus including a backing plate and at least one “U” shaped structure emanating from and secured to the backing plate to form a closed loop, and a method for attaching a pad of friction material to a backing plate. The apparatus comprises at least one rigid structure attached to the backing plate in at least two places. These structures form at least one closed loop with the backing plate. The pad is formed around the structures, completely surrounding the structures. In the preferred embodiment, the structures are two “U” shaped loops made of friction material, so that the pad can continue to be used when the pad wears down to the level of the loops.

A general object of the present invention is to provide an easily manufactured apparatus for attaching a pad of friction material to a backing plate.

It is another object of the present invention to attach the pad to the backing plate with a minimum amount of chemical adhesives.

It is yet another object of the present invention to increase the depth of the pad that can be used before the pad and backing plate must be replaced.

This and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the preferred embodiment of the present invention showing a backing plate having a pair of “U” shaped loops emanating from and fixedly secured to the backing plate;

FIG. 2 is a perspective view of a backing plate and brake pad with the preferred embodiment of the present invention shown within the brake pad;

FIG. 3 is a perspective view of a backing plate with the preferred embodiment of the present invention shown above the backing plate;

FIG. 4 is a cross sectional view taken along the line I-I in FIG. 2 of a backing plate and brake pad with the preferred embodiment of the present invention shown within the brake pad.

### DETAILED DESCRIPTION OF THE PREFERRED EMBODIMENT

It should be appreciated that in the detailed description of the invention which follows that like reference numbers on different drawing views are intended to identify identical structural elements of the invention in the respective views. In addition, the figures show the present invention holding a brake pad to a backing plate. It should be readily apparent to those skilled in the art that the present invention may also be used to hold a clutch pad to a backing plate. Using the present invention to hold a clutch pad, a disc brake pad, or a drum brake pad to a backing plate is intended to be within the spirit and scope of the invention as claimed.

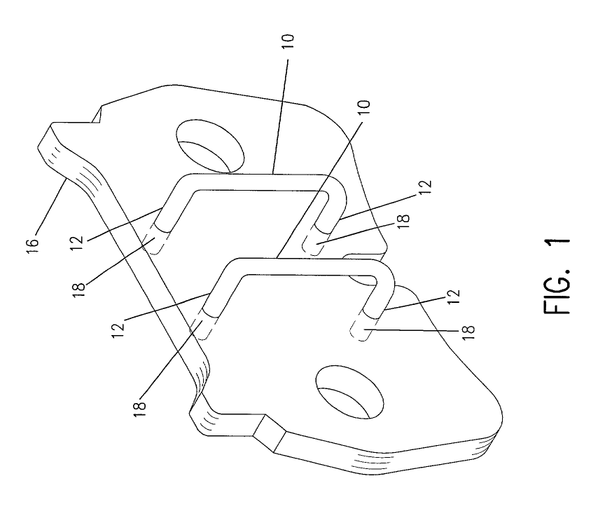

The preferred embodiment of a pad retention apparatus is shown in perspective in FIG. 1 and designated 10. Apparatus 10 is a pair of “U” shaped loops with legs 12. Legs 12 are attached to backing plate 16 at holes 18. Holes 18 are drilled through backing plate 16 for legs 12 to be inserted in before attachment to increase the strength of the connections. Drilling, machining, electrical discharge, or any other method known in the art may be used to cut the holes. In the preferred embodiment, apparatus 10 is mechanically attached to backing plate 16, but the attachment can be a chemical bond as well. Possible mechanical attachment methods include, but are not limited to: welding, brazing, coining, swaging, and interference fitting.

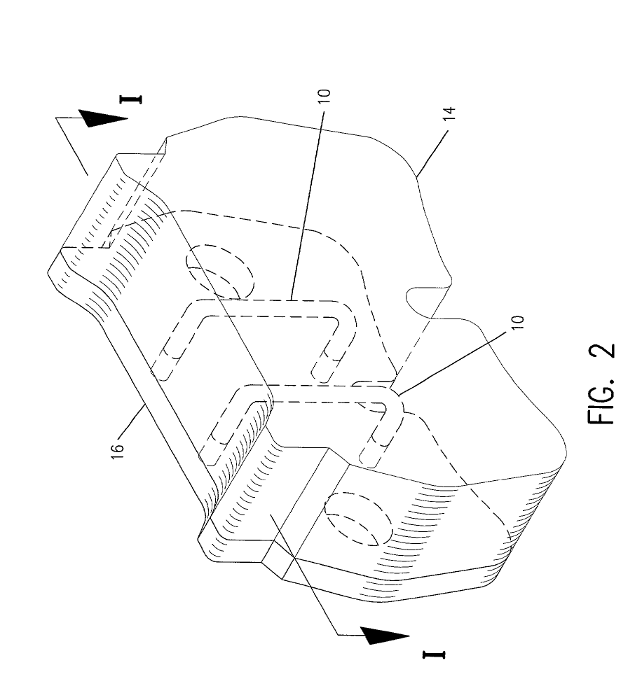

As shown in perspective in FIG. 2, brake pad 14 is formed on backing plate 16 such that apparatus 10 is completely enveloped within brake pad 14.

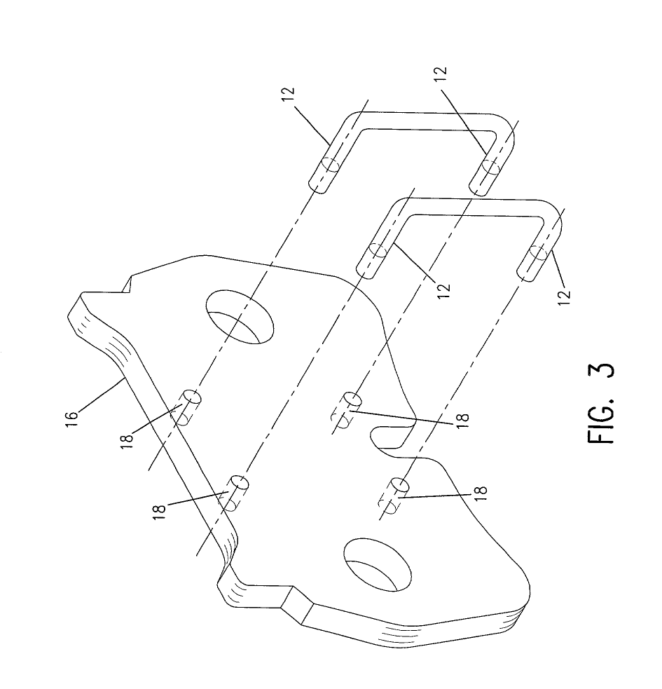

FIG. 3 is a perspective view showing legs 12 before they are placed in holes 18 in backing plate 16. The loops may be formed by cutting wire to a specified length, and then hydraulically or pneumatically forming the wire into the “U” shape shown. The number, size, and thickness of the loops may vary, and is dependent on the shape of pad 14 and the intended use. It should be readily apparent to those skilled in the art that other shapes for the structure can be used just as effectively. For example, the loops may be “C” shaped, “W” shaped, “V” shaped, or made in virtually any other shape that is capable of forming a closed loop. All these other configurations are intended to be within the spirit and scope of the invention as claimed, and to be within the penumbra of the definition of the phrase “U” shaped.

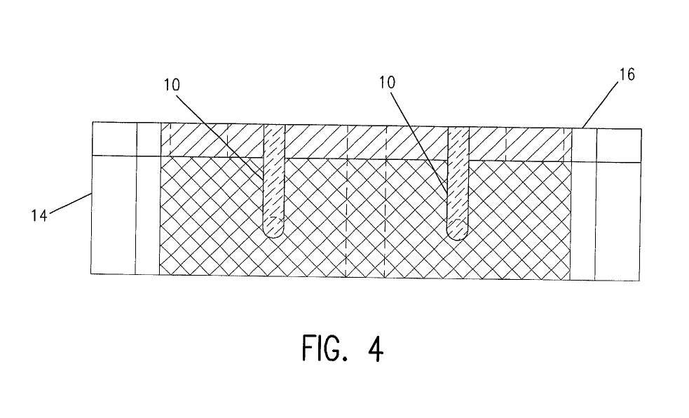

As shown in cross sectional view in FIG. 4, apparatus 10 is completely surrounded by brake pad 14. A chemical adhesive may be used on the surface of apparatus 10 to bond apparatus 10 to brake pad 14, but this is not required. In addition, other methods of strengthening the bond between backing plate 16 and brake pad 14 may be used. Such methods may include, but are not limited to: treating backing plate 16 with adhesives, sandblasting, etching, cutting, grooving, or raking backing plate 16. These methods for treating a backing plate are well known in the art.

Also in the preferred embodiment, apparatus 10 is made of friction material. Friction material is a substance formulated to dissipate the kinetic energy of the vehicle when a brake pad made of the friction material is brought in contact with a brake rotor or drum. Similar materials are used in clutch pads. Friction material is also known in the art as brake lining material. As brake pad 14 wears down to the level of apparatus 10, apparatus 10 does not damage the brake rotor. Thus, brake pad 14 can be used longer before being replaced. Apparatus 10 can be constructed of friction material using powder metallurgy or any other method known in the art. The friction material used may be asbestos, metallic powders, graphite, fiberglass, ceramics, copper, brass, iron, silicon carbide, or any other friction material known in the art.

Thus, it is seen that the objects of the present invention are efficiently obtained, although modifications and changes to the invention should be readily apparent to those having ordinary skill in the art, and these modifications are intended to be within the spirit and scope of the invention as claimed.

What we claim is:

1. An apparatus for attaching a pad of friction material to a backing plate comprising:
at least one rigid structure attached to said backing plate in at least two places, said structure operatively arranged to form at least one closed loop with said backing plate.

2. The apparatus recited in claim 1 wherein said structure is operatively arranged to be surrounded by said pad.

3. The apparatus recited in claim 1 wherein said structure is mechanically attached to said backing plate.

4. The apparatus recited in claim 3 wherein said mechanical attachment method is welding.

5. The apparatus recited in claim 1 wherein said structure is chemically bonded to said backing plate.

6. The apparatus recited in claim 1 wherein said structure is a pair of “U” shaped loops, each of said loops having a pair of legs, said legs attached to said backing plate.

7. The apparatus recited in claim 1 wherein said structure is fabricated from friction material.

8. A method for attaching a pad of friction material to a backing plate comprising:
attaching at least one rigid structure to said backing plate in at least two places, where said structure forms a closed loop with said backing plate; and
forming said pad on said backing plate.

9. The method recited in claim 8 wherein said pad completely surrounds said structure.

10. The method recited in claim 8 wherein said structure is mechanically attached to said backing plate.

11. The apparatus recited in claim 10 wherein said mechanical attachment method is welding.

12. The method recited in claim 8 wherein said structure is chemically bonded to said backing plate.

13. The method recited in claim 8 wherein said structure is a pair of “U” shaped loops, each of said loops having a pair of legs, said legs attached to said backing plate.

14. The method recited in claim 8 wherein said structure is fabricated from friction material.

15. An apparatus for holding a pad, comprising:
a backing plate; and,
at least one rigid closed loop structure emanating from and fixedly secured to said backing plate.

16. The apparatus recited in claim 15 wherein said pad is a brake pad.

17. The apparatus recited in claim 15 wherein said pad is a clutch pad.

18. An article of manufacture comprising:
a backing plate;
at least one rigid closed loop structure emanating from and fixedly secured to said backing plate; and
a pad of friction material at least partially surrounding said structure.

19. The article recited in claim 18 wherein said pad is a disc brake pad.

20. The article recited in claim 18 wherein said pad is a drum brake pad.

21. The article recited in claim 18 wherein said pad is a clutch pad.
